(19) United States
(12) Patent Application Publication
(10) Pub. No.: US 2015/0052997 A1
(43) Pub. Date: Feb. 26, 2015

(54) Hydrostatic Interface Measuring Device

(71) Applicant: Endress + Hauser GmbH + Co. KG, Weil am Rhein (DE)

(72) Inventor: Marc Andreas Schlachter, Wehr (DE)

(21) Appl. No.: 14/463,104

(22) Filed: Aug. 19, 2014

(30) Foreign Application Priority Data
Aug. 23, 2013 (DE) 10 2013 109 128.8

(51) Int. Cl. G01F 23/14

(52) U.S. Cl. CPC G01F 23/14
USPC 73/299

(57) ABSTRACT

An interface measuring device for ascertaining the height of an interface between a first phase (2; 102) of a medium with a first density and a second phase (4; 104) of a medium with a second density, comprising: a first pressure registering point (12; 112) for registering a first pressure of a medium at a first height (H₁); a second pressure registering point (14; 114) for registering a second pressure of the medium at a second height (H₂), an evaluation apparatus (30; 130), wherein a height separation (ΔH) between the first pressure registering point and the second pressure registering point is known, wherein the second height (H₂) lies above a height range, in which the interface is expected, and wherein the evaluation apparatus is adapted, based on the registered pressures (p₁, p₂), respectively a pressure difference (Δp) between the registered pressures, as well as based on a first density value and a second density value, respectively a density difference between the density values, to determine a height of an interface.

The present invention relates to a hydrostatic interface measuring device for ascertaining the height of an interface on a medium in a container. An interface arises as a result of the separation of components or phases of different density in a gravitational field, i.e. under the influence of gravity. For reliable interaction with the medium, it is advantageous to know the height of the interface. Fill level measuring devices using freely radiated or guided microwaves can detect the phase boundary between the medium and the interface as an echo signal. This proves to be difficult, however, when the phase boundary is not sharply defined or the jump in the dielectric constant is too small.

An object of the present invention is to provide an interface measuring device, whose accuracy of measurement does not depend on the dielectric constants of the participating phases.

The object is achieved according to the invention by a measuring device as defined in independent patent claim 1.

The hydrostatic interface measuring device of the invention includes a first pressure registering point for registering a first pressure of a medium at a first height and a second pressure registering point for registering a second pressure of the medium at a second height (H₂), wherein there is a height separation between the first pressure registering point and the second pressure registering point, wherein the measuring device further includes an evaluation apparatus, wherein the evaluation apparatus is adapted, based on the registered pressures (p₁, p₂), respectively a pressure difference (Δp=p₁−p₂) between the registered pressures, as well as based on a first density value and a second density value, respectively a density difference between the density values, to determine the height of an interface.

In a further development of the invention, a first pressure tap includes a first pressure measuring transducer for measuring the first pressure p1 and a second pressure tap includes a second pressure measuring transducer for measuring the second pressure.

In a further development of the invention, the measuring- and evaluation apparatus is furthermore provided, based on at least one pressure measured value, to determine a fill level of the medium.

In a further development of the invention, the evaluation apparatus includes a data memory, wherein the first density value and/or the second density value, respectively a density difference between the density values, is/are furnished in the data memory.

In a further development of the invention, the hydrostatic interface measuring device further includes at least one measuring arrangement for ascertaining at least one of the density values.

In a further development of the invention, the measuring device includes for ascertaining at least one of the density values a vibronic densimeter, which is arranged especially neighboring a pressure measuring transducer.

In a further development of the invention, the measuring device includes for ascertaining the first density value a third pressure measuring transducer, which is arranged vertically spaced from the first pressure measuring transducer at a third height (H₃), wherein the evaluation apparatus is adapted to ascertain the first density measured value based on a difference of the hydrostatic pressures at H1 and H3.

In a further development of the invention, the height Hᵢ of the interface is ascertained based on the following equation or an equivalent thereof:

$${H}_{i} = {H}_{2} - \frac{Δ {p}_{0} ( {ρ}_{1} ) - Δ p}{Δρ \cdot g} ,$$

wherein Δp=p₁−p₂ is the measured difference between the first pressure and the second pressure, wherein Δp₀(ρ₁) corresponds to a difference between the first pressure and the second pressure for the case, in which the height of the interface Hᵢ amounts to zero, and wherein Δρ is the difference between the first density and the second density.

The expression Δp₀(ρ₁) is a variable ascertained by calculation according to the formula:

Δp₀(ρ₁)=(H₂−H₁)·g·ρ₁=(ΔH·g)·ρ₁,

wherein g is the acceleration of gravity.

The value (ΔH·g) can be furnished as an (installation dependent) constant in the evaluation unit, in order to minimize the number of computational steps for ascertaining the height of the interface.

The invention will now be explained in greater detail based on the examples of embodiments illustrated in the drawing, the figures of which show as follows:

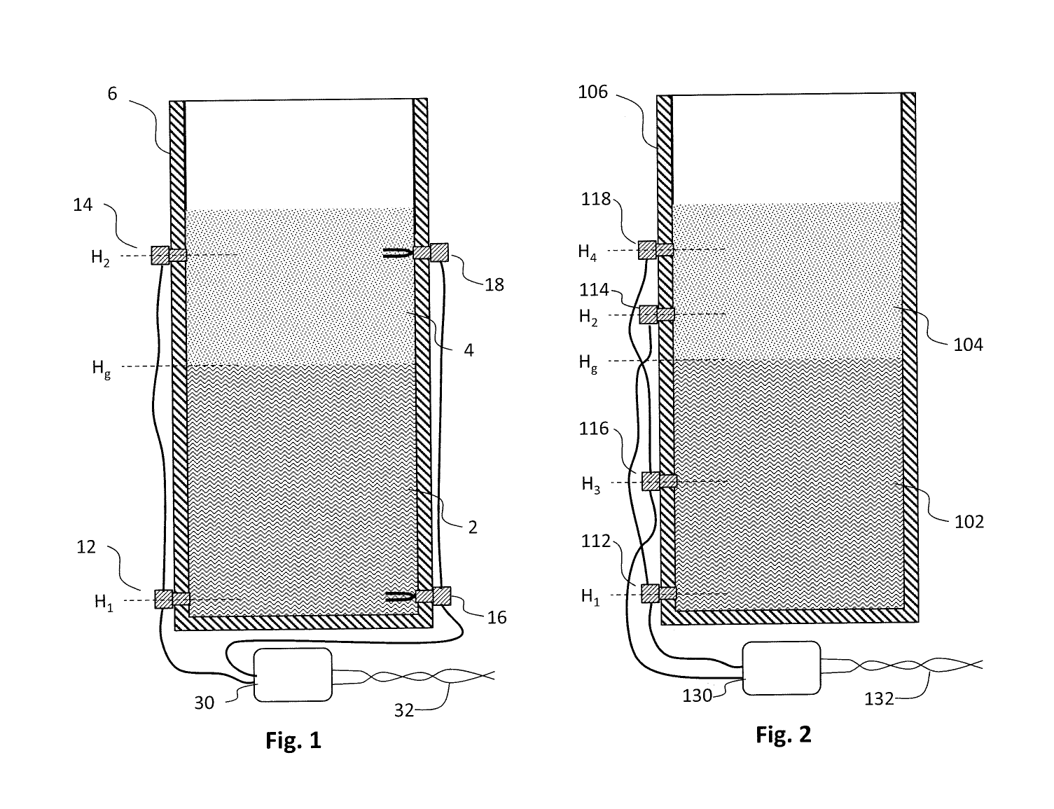

FIG. 1 a schematic representation of a first example of an embodiment of a measuring device of the invention; and

FIG. 2 a schematic representation of a second example of an embodiment of a measuring device of the invention.

FIG. 1 shows a first example of an embodiment of a hydrostatic interface measuring device of the invention in a measuring situation of the field of the invention, in the case of which a first phase 2 and a second phase 4 of a medium are contained in a tank 6, wherein the task of the measuring device is to ascertain a height Hᵢ of an interface between the first phase 2 and the second phase 4. The measuring device includes a first pressure measuring transducer 12 and a second pressure measuring transducer 14, as well as an evaluation unit 30, wherein mounted on the tank are the first pressure measuring transducer 12 at a height H₁ and the second pressure measuring transducer 14 at a height H₂ above the first pressure measuring transducer 12. The second pressure measuring transducer 14 is connected via a cable with the first pressure measuring transducer 12, which, in turn, is connected to the evaluation unit 30. Pressure measurement values of the second pressure measuring transducer 16, which represent a pressure p₂ at the height H₂, are transmitted to the first pressure measuring transducer, wherein the first pressure measuring transducer transmits the pressure measurement values of the first pressure p1 at the first height H₁ and the pressure measurement values of the second pressure to the evaluation unit. The evaluation unit 16 is designed, based on the transmitted pressure measurement values, to determine a pressure difference Δp between the first pressure and the second pressure and the height Hᵢ of the interface between a first phase and a second phase.

This can especially occur according to the equation

$${H}_{i} = {H}_{2} - \frac{Δ {p}_{0} ( {ρ}_{1} ) - Δ p}{Δρ \cdot g} \qquad ( I )$$

For determining the calculated variable

Δp₀(ρ₁)=(ΔH·g)·ρ₁ (II)

for example, the installation dependent value (ΔH·g) is stored in the evaluation unit for subsequent multiplication with the density pi of the first phase.

Further required for determining the height of the interface Hᵢ based on the above equation are knowledge of the height H₂, a first density ρ₁ of the first phase and the difference Δρ between the first density and a second density ρ₂ of the second phase. The height H2 is installation dependent and likewise stored in the evaluation unit. The density values can be provided in different ways.

As shown in FIG. 1, there are arranged in the height range of the first phase, especially at the height H₁, a first vibronic density measuring device 16, and in the height range of the second phase, especially at the height H₂, a second vibronic density measuring device 18. Such vibronic density measuring devices can be, for example, an oscillatory fork sensor sold by the applicant under the designation “Liquiphant M density”. The density values ascertained by the vibronic density measuring devices 16, 18 for the first and second phases are provided to the evaluation unit 30, which has therewith all required variables for ascertaining the height of the interface Hᵢ based on the equations I and II. The ascertained value can be output via lines 32 to a receiver, especially to a control system.

With knowledge of the density ρ₂ of the second phase, based on the pressure measured value of the second pressure measuring transducer 14 for the second pressure p₂, also the height of the second phase above the height H₂ can be ascertained, to the extent that the tank is in communication with the surrounding air, and the second pressure measuring transducer is a relative pressure measuring transducer, which measures the pressure in the tank with reference to the surrounding air pressure. Of course, the first and the second pressure measuring transducers should have the same reference variable, thus both be relative pressure transducers or both be absolute pressure measuring transducers. To the extent that the tank is closed, determining the fill level requires an additional pressure measuring transducer for determining a so-called headspace pressure, thus the pressure of a gas phase above the first and second phases. Also, this third pressure measuring transducer should have the same reference variable as the first and second pressure measuring transducers.

FIG. 2 shows a second example of an embodiment of a hydrostatic interface measuring device of the invention in a measuring situation of the field of the invention, wherein a first phase 102 and a second phase 104 of a medium are contained in a tank 106, wherein the task of the measuring device is to determine a height Hᵢ of an interface between the first phase 102 and the second phase 104.

The measuring device includes a first pressure measuring transducer 112 and a second pressure measuring transducer 114, as well as an evaluation unit 130, wherein mounted on the tank are the first pressure measuring transducer 112 at a height H₁, and the second pressure measuring transducer 114 at a height H₂ above the first pressure measuring transducer 112. The second pressure measuring transducer 114 is connected via a cable with the first pressure measuring transducer 112, which, in turn, is connected to the evaluation unit 130. Pressure measurement values of the second pressure measuring transducer 116, which represent a pressure p₂ at the height H₂, are transmitted to the first pressure measuring transducer, wherein the first pressure measuring transducer transmits the pressure measurement values of the first pressure p1 at the first height H₁ and the pressure measurement values of the second pressure to the evaluation unit.

Evaluation unit 116 is designed, based on the transmitted pressure measurement values, to determine a pressure difference Δp between the first pressure and the second pressure and the height Hᵢ of the interface between a first phase and a second phase, especially according to the equation ascertained in connection with the first example of an embodiment and the procedure described there.

For ascertaining the first density ρ₁ of the first phase 102 and the second density ρ₂ of the second phase, the measuring arrangement further includes a third pressure measuring transducer 116 and a fourth pressure measuring transducer 118, wherein the third pressure measuring transducer 116 is arranged at a height H₃, in the region of the first phase 102 and above the first height H₁, and wherein the fourth pressure measuring transducer 118 is mounted on the tank at a height H₄ above the second pressure measuring transducer 114 in the region of the second phase 104. The fourth pressure measuring transducer is connected via a cable with the third pressure measuring transducer 116, which, in turn, is connected with the evaluation unit 130. Pressure measurement values of the fourth pressure measuring transducer 118, which represent a pressure p₄ at the height H₄, are transmitted to the third pressure measuring transducer 116, wherein the third pressure measuring transducer transmits the pressure measurement values of the third pressure p₃ at the third height H₃ and the pressure measurement values of the fourth pressure to the evaluation unit.

Based on this data, then the density values can be ascertained based on the equations

$${ρ}_{1} = \frac{{p}_{1} - {p}_{3}}{g \cdot ( {H}_{3} - {H}_{1} )} and {ρ}_{2} = \frac{{p}_{2} - {p}_{4}}{g \cdot ( {H}_{4} - {H}_{2} )}$$

With the above density values then, in turn, the height Hᵢ of the interface can be calculated, wherein used for this are, basically, besides the above discussed application of the difference between the first pressure p₁ and the second pressure p₂ and the height difference H₂−H₁, also the difference between the third pressure p₃ and the fourth pressure p₄ and the height difference H₄−H₃. After the height of the interface Hᵢ has been determined based on both value sets, a comparison of the results offers the opportunity for gaining information concerning the validity of the established height of the interface. Output as measurement result can be the average value of the two ascertained values for the height of the interface.

Finally, for simplifying the measuring arrangement, instead of measuring the density, predetermined density values can be stored in the evaluation unit, when the density values of the first and second phases are only variable to a degree permitting the height of the interface to be ascertained with the desired accuracy by assuming the validity of the stored density values. In an additional embodiment, the density values of the phases can be ascertained based on models stored in the evaluation unit for the temperature— and, in given cases, pressure dependence of the densities of the phases, wherein then a temperature ascertainment in both phases is required. Applied for this can be, respectively, a temperature sensor integrated into the pressure measuring transducer or a separately arranged temperature sensor.

1-9. (canceled)

10. A hydrostatic interface measuring device for ascertaining the height of an interface between a first phase of a medium with a first density and a second phase of a medium with a second density, comprising:
a first pressure registering point for registering a first pressure of a medium at a first height;
a second pressure registering point for registering a second pressure of the medium at a second height, and
an evaluation apparatus, wherein:
a height separation between the first pressure registering point and the second pressure registering point is known;
the second height lies above a height range, in which the interface is expected; and
said evaluation apparatus is adapted, based on the registered pressures, respectively a pressure difference between the registered pressures, as well as based on a first density value and a second density value, respectively a density difference between the density values, to determine a height of an interface.

11. A hydrostatic interface measuring device as claimed in claim 10, wherein:
the first pressure registering point has a first pressure measuring transducer for measuring a first pressure; and
the second pressure registering point has a second pressure measuring transducer for measuring the second pressure.

12. The hydrostatic interface measuring device as claimed in claim 11, wherein:
the measuring- and evaluation apparatus furthermore is provided, based on at least one pressure measured value, to determine a fill level of the medium.

13. The hydrostatic interface measuring device as claimed in claim 10, wherein:
said evaluation apparatus has a data memory; and
the first density value and/or the second density value, respectively a density difference between the density values, is/are furnished in the data memory.

14. The hydrostatic interface measuring device as claimed in claim 10, further comprising:
at least one measuring arrangement for ascertaining at least one of the density values.

15. The hydrostatic interface measuring device as claimed in claim 10, wherein:
the measuring arrangement includes for ascertaining at least one of the density values at least one vibronic densimeter, which is arranged especially neighboring a pressure registering point.

16. The hydrostatic interface measuring device as claimed in claim 10, wherein:
the measuring arrangement includes for ascertaining the first density value a third pressure registering point, which is arranged vertically spaced from the first pressure registering point at a third height; and
said evaluation apparatus is adapted to ascertain the first density measured value based on a difference of the hydrostatic pressures at the first and third height.

17. The hydrostatic interface measuring device as claimed in claim 10, wherein:
the measuring arrangement includes for ascertaining the first density value a fourth pressure registering point, which is arranged vertically spaced from the second pressure registering point at a fourth height; and
said evaluation apparatus is adapted to ascertain the second density measured value based on a difference of the hydrostatic pressures at the second and fourth height.

18. The hydrostatic interface measuring device as claimed in claim 10, wherein:
the height of the interface is ascertained based on the following equation or an equivalent equation:
$${H}_{i} = {H}_{2} - \frac{Δ {p}_{0} ( {ρ}_{1} ) - Δ p}{Δρ \cdot g} ,$$
wherein Δp is the measured difference between the first pressure and the second pressure,
wherein Δp₀(ρ₁) corresponds to a difference between the first pressure and the second pressure for the case, in which the height of the interface H_{g} amounts to zero, and
wherein Δρ is the difference between the first density and the second density.
